(19) United States
(12) Patent Application Publication
(10) Pub. No.: US 2013/0075341 A1
(43) Pub. Date: Mar. 28, 2013

(54) METHOD FOR CLARIFYING INDUSTRIAL WASTEWATER

(71) Applicants: Robert Davis, Carmel, IN (US); Stuart Davis, Fernandina Beach, FL (US)

(72) Inventors: Robert Davis, Carmel, IN (US); Stuart Davis, Fernandina Beach, FL (US)

(21) Appl. No.: 13/491,008

(22) Filed: Jun. 7, 2012

Related U.S. Application Data
(63) Continuation of application No. 13/453,484, filed on Apr. 23, 2012.
(60) Provisional application No. 61/537,953, filed on Sep. 22, 2011.

(51) Int. Cl. C02F 1/54

(52) U.S. Cl. 210/727

(57) ABSTRACT

Methods are described for removing contaminates from aqueous industrial wastewater process streams, specifically industrial laundries to yield a less contaminated aqueous effluent for discharge to a sewer and reduce the sludge generated therefrom. A premixed medium/high molecular weight and medium/high charged cationic coagulant solution polymer and an inorganic aluminum species is added to the wastewater, and after at least a two second delay, a high molecular weight highly charged anionic flocculent is injected into the wastewater which reduces sludge generation, while maintaining or exceeding effluent quality. Also, no coagulant, flocculent or sludge aids are needed to attain the results and the sludge can be dewatered in a plate and frame press.

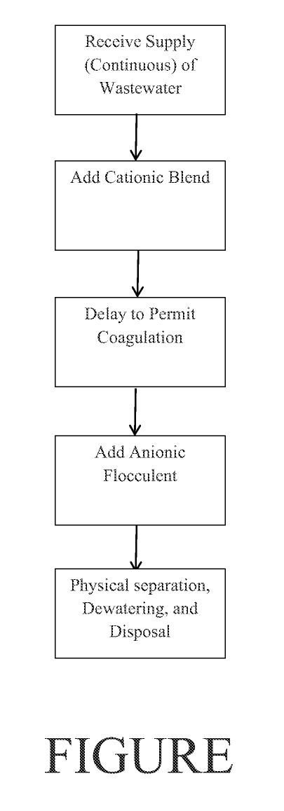

### CROSS-REFERENCE TO RELATED APPLICATIONS

This application is a continuation of U.S. patent application Ser. No. 13/453,484 filed Apr. 23, 2012, which is incorporated herein by reference, and claims the benefit of priority of U.S. provisional application 61/537,953 filed on Sep. 22, 2011.

### FIELD OF THE INVENTION

This invention is directed to methods of clarifying wastewater, in particularly exemplary embodiments industrial laundry wastewater that includes wastewater from light to heavy product mix industrial laundry plants.

### BACKGROUND

In the laundry wastewater treatment field of solids/liquid separation, suspended and emulsified solids are removed from water by a variety of processes, including sedimentation, straining, flotation, filtration, coagulation, flocculation, and emulsion breaking among others. Additionally, after solids are removed from the wastewater they are often dewatered. Liquids treated for solids removal often have as little as several parts per million (ppm) of suspended solids or dispensed oils, or may contain several thousand ppm of suspended solids or oils. Solids generated as sludge may contain anywhere from 0.1 to 6 weight percent solids prior to dewatering, and from 20 to 50 weight percent solids after dewatering by a plate and frame press. Solids/liquid separation processes are designed to separate solids from liquids. The more solids generated in the process, the more costly the processing and disposal.

While strictly mechanical techniques have been used to effect solids/liquid separation, the modern methods often rely on mechanical separation techniques that are augmented by “chemical” treatment in which synthetic and natural polymeric materials are added to accelerate the rate at which solids can be removed from water. Chemical treatment for wastewater clarification is typically employed when it is necessary or desirable to remove colloidal and microemulsified solids so that the total petroleum hydrocarbons (TPH), fat, oil and grease (FOG), biochemical oxygen demand (BOD), chemical oxygen demand (COD), total suspended solids (TSS), and other contaminants being discharged to a receiving stream can be minimized. In the industrial laundry industry, the chemical treatment of wastewater to a typical municipal standard of 100 ppm of oil and grease (EPA method 1664) has involved the hydraulic equalization of untreated wastewater followed by the metered flow of the ^{w} astewater through a pipe or tanks to provide for retention time for the injection of a variety of chemicals.

Typically, chemical treatment involves using a cationic coagulant with one or more inorganic components, together as a coagulant aid, followed by addition of an anionic flocculent and a sludge condition. Coagulation is the process of destabilization of the colloid waste particle by adding the coagulant (for example, at 50-700 ppm) to adsorb the waste particles by charge neutralization to form coagulated particles (microfloc) and impart residual cationic surface charge to the coagulated particles. A coagulant aid, e.g., ferric chloride, aluminum sulfate, ferrous sulfate, calcium chloride, polyaluminum chloride, and/or others is then added (for example, typically at a rate of 75-700 ppm depending on the species) to increase the ability to form a more highly cationic surface that will cause the further adsorption of the coagulated particles onto the surface of a flocculent to be added subsequently. The inorganic components used for coagulation or as coagulation aids typically have simple hydration factors of approximately 6-12 water molecules.

Flocculation occurs when the highly charged anionic flocculent bridges the previously formed cationic coagulated particles to form agglomerated particles. High molecular weight cationic dispersion polymer flocculents and processes of making the same are described in U.S. Pat. Nos. 5,006,590 and 4,929,655. Once neutralized, the agglomerated particles no longer repel each other and can come together to form larger agglomerated solids or sludge, which may then be removed from the water.

Sludge conditioners may also be added to assist in dewatering the sludge. Such sludge conditioners include, for example, perlite, diatomaceous earth, bentonite clay and others. Sludge conditions act as a “body builder” to produce sludge for dewatering in downstream processes.

Additionally, clarification chemicals also may be added during wastewater processing. Clarification chemicals are typically utilized in conjunction with mechanical clarifiers including dissolved air flotation systems (DAFs), induced air flotation systems (IAFs), and settlers for the removal of solids from the treated water. The clarification chemicals coagulate and/or flocculate the suspended solids into larger particles, which can then be removed from the water by gravitational settling, flotation, or other mechanical techniques. High molecular weight, high active polymer cationic solution polymers for water clarification are disclosed in U.S. Pat. No. 6,171,505.

A variety of organic and inorganic coagulants, aids, conditioners, and clarification chemicals are available in the marketplace. Historical data has shown that used in correct combination, these chemistries can produce suitable effluent with sludge generation of approximately 1.1 to 2.0 percent by volume (per gallons treated) of influent flow.

A drawback to the above-described processes is that the addition of so many coagulants, coagulant aids, flocculents, sludge conditioners, dewatering aids and/or clarification chemicals can add significantly to the amount of sludge produced and the cost of treatment and subsequent sludge removal. While it is desirable to remove colloidal and microemulsified solids from the wastewater, it is also desirable to carry out the process efficiently, which includes the substantial reduction or elimination of additional sludge generated by the added processing chemicals. This problem is particularly exasperated by the use of coagulant aids which, as mentioned above, have high hydration factors and thus can produce hydrated particles that require removal. As discussed in further detail below, certain aspects and embodiments of this invention are specifically directed to the practice of methods that allow for the elimination or at least substantial reduction coagulant aids and/or sludge thickeners, without compromising the ability of the method to remove colloidal and microemulsified solids. Certain aspects and embodiments are directed to an overall reduction of the formation of sludge by up to, for example, 80 weight percent compared to previous historically used methods by eliminating or substantially reducing the use of such coagulant aids, sludge thickeners, and the like.

### SUMMARY OF THE INVENTION

A first aspect of the invention provides a method for clarifying wastewater containing contaminants. According to this first aspect, a cationic blend including at least methanamine, N-methyl-, polymer with 2-(chloromethyl) oxirane and aluminum chlorohydrate (ACH) is added to the wastewater in an effective amount to break emulsified bonds of the contaminants in the wastewater and produce cationic-charged coagulated particles having sufficient mass and cationic charge to react with an anionic flocculent to be added thereafter. After a sufficient delay to permit the cationic blend to coagulate the cationic-charged coagulated particles in the wastewater, the anionic flocculent is added to the wastewater in an effective amount to react with the cationic-charged coagulated particles to form flocculated waste particles of effective size to form sludge in disposable clarified water.

A second aspect of the invention provides a method for clarifying wastewater containing contaminants. According to this second aspect, a cationic blend including at least methanamine, N-methyl-, polymer with 2-(chloromethyl) oxirane and aluminum chlorohydrate (ACH) is added to the wastewater in an amount of between about 25 ppm and about 1500 ppm to break emulsified bonds of the contaminants in the wastewater and produce cationic-charged coagulated particles having sufficient mass and cationic charge to react with an aqueous anionic flocculent to be added thereafter. After a sufficient delay to permit the cationic blend to substantially complete coagulation of the cationic-charged coagulated particles in the wastewater, the aqueous anionic flocculent in an amount of between about 5 ppm and about 50 ppm and of sufficient molecular weight and charge density is added to the wastewater to react with the cationic-charged coagulated particles to form flocculated waste particles of effective size to form sludge in disposable clarified water.

A third aspect of the invention provides a method for clarifying wastewater containing contaminants. According to this third aspect, a cationic blend including at least about 5 to about 50 weight percent of methanamine, N-methyl-, polymer with 2-(chloromethyl) oxirane and about 5 to about 40 weight percent of aluminum chlorohydrate (ACH) is added to the wastewater in an amount of between about 25 ppm and about 1500 ppm to break emulsified bonds of the contaminants in the wastewater and produce cationic-charged coagulated particles having sufficient mass and cationic charge to react with all aqueous anionic flocculent to be added thereafter. After a sufficient delay to permit the cationic blend to substantially complete coagulation of the cationic-charged coagulated particles in the wastewater, the aqueous anionic flocculent in an amount of between about 5 ppm and about 50 ppm and of sufficient molecular weight and charge density is added to the wastewater to react with the cationic-charged coagulated particles to form flocculated waste particles of effective size to form sludge indisposable clarified water.

Other aspects of the invention, including apparatus, devices, indicators, kits, compositions, other methods and processes, and the like which constitute part of the invention, will become more apparent upon reading the following detailed description of the exemplary embodiments.

### BRIEF DESCRIPTION OF THE DRAWING(S)

The accompanying drawing is incorporated in and constitute a part of the specification. The drawing, together with the general description given above and the detailed description of the exemplary embodiments and methods given below, serves to explain the principles of exemplary embodiments of the invention. In such drawing, an industrial laundry wastewater treatment system embodying features of an exemplary embodiment of this invention is illustrated.

### DETAILED DESCRIPTION OF THE EXEMPLARY EMBODIMENTS AND EXEMPLARY METHODS

Reference will now be made in detail to exemplary embodiments and methods of the invention. It should be noted, however, that the invention in its broader aspects is not necessarily limited to the specific details, representative materials and methods, and illustrative examples shown and described in connection with the exemplary embodiments and methods.

In accordance with exemplary embodiments of the present invention described herein below, methods are provided for removing contaminants from an aqueous solution. The methods described herein are particularly useful in connection with wastewater discharged from light to heavy product mix industrial laundry plants. Wastewaters which may be treated by processes described herein include, for example, wastewater from industrial cleaning of products such as uniforms, shop towels, ink towels, mats, rugs, bar towels, aprons, coveralls, and coats. The materials and methods disclosed herein may also be used to protect personnel from manufacturing or commercial wastes. Wastewater can be generated by the use of commercial equipment used for washing various products. The streams are collected in such a way as to promote the batch collection or intermittent or continuous flow of the wastewater in a stream. The collection of the wastewater then may be further treated by batch or flow proportion as to allow for the injection and mixing of treatment chemicals by primary coagulation and flocculation, as described below.

Exemplary methods disclosed herein are particularly useful for removing contaminants such as surfactants, phenolics, total petroleum hydrocarbons, fats oil and grease, TSS contributors, BOD contributors, COD contributors, and/or TOC contributors from wastewater. Unless otherwise stated, process and apparatus parameters disclosed for FOG removal are equally or substantially equally effective for the removal of many if not all of the other above-listed contaminants as well. Likewise, unless otherwise stated, all process and apparatus parameters disclosed for the removal of the other non-volatile contaminants are equally or substantially equally effective for heavy metal removal as well.

Referring now more particularly to the FIGURE, a cationic blend including at least methanamine, N-methyl-, polymer with 2-(chloromethyl) oxirane (also known as epichlorohydrin-dimethylamine condensation polymer and/or poly[2-hydroxypropyl-N,N-dimethylammonium chloride], and allotted CAS 25988-97-0) and aluminum chlorohydrate (ACH) is injected or otherwise added to the wastewater in an effective amount to break emulsified bonds of the contaminants in the wastewater and produce cationic-charged coagulated particles having sufficient mass and cationic charge to react with an anionic flocculent to be added thereafter, desirably without the use of a coagulant aid for increasing the cationic charge of the coagulated particles. The blend, based on its total weight, may include between about 5 to about 50 weight percent solids of methanamine, N-methyl-, polymer with 2-(chloromethyl) oxirane and between about 5 to about 40 weight percent solids of ACH. In another embodiment, the blend includes about between 5 to about 50 weight percent solids methanamine, N-methyl-, polymer with 2-(chloromethyl) oxirane and between about 2 to about 27 weight percent ACH. As used herein, the term “between” as used herein is inclusive, such that, for example, the range of about 5 to about 40 weight percent includes about 5 weight percent and about 40 weight percent.

The ACH is also known as partially neutralized polyaluminum chloride, and may be introduced in combination with other chloride species where ACH is the major constituent. The ACH and methanamine, N-methyl-, polymer with 2-(chloromethyl) oxirane may be premixed. The methanamine, N-methyl-, polymer with 2-(chloromethyl) oxirane may be a medium to high molecular weight, medium to very highly charged cationic solution coagulant. The aqueous methanamine, N-methyl-, polymer with 2-(chloromethyl) oxirane (a polymeric coagulant polyamine) is made by several manufacturers and of pre-described weight percent of solids combined with the aqueous polyaluminum chloride. The methanamine, N-methyl-, polymer with 2-(chloromethyl) oxirane and ACH are mixed in controlled conditions with water to produce a cationic blend polymer and then injected into the waste stream in empirical quantities of for example, about 25 to about 1500 parts per million (ppm), more particularly in certain exemplary embodiments about 50 to about 700 ppm, depending primarily on stream flow rate or waste concentration to cause the coagulation of negatively charged waste particles. The coagulant may be added in diluted or undiluted form. In is also possible to inject or otherwise add the methanamine, N-methyl-, polymer with 2-(chloromethyl) oxirane and the ACH to the wastewater separately, though this is not necessarily preferred.

After the addition of the coagulant, yet prior to the addition of an anionic flocculent, a sufficient time delay is allowed to permit the cationic blend to coagulate, preferably substantially completely coagulate, the cationic-charged coagulated particles in the wastewater so that the resulting coagulated particles should have sufficient mass and residual cationic charge to react with the subsequent addition of a wetted, water dispersed anionic flocculent to create an agglomerated particle of sufficient size for mechanical removal. A delay time of at least about two (2) seconds (from the time the coagulant blend is added to the time the flocculent is added) is typically sufficient to permit the coagulation, and preferably the substantially complete coagulation of the particles. The time periods for the coagulant to sufficiently coagulate the waste particles prior to injection of the flocculent is no less than about two (2) seconds and no longer than about ten (10) minutes. Although time intervals of greater than ten (10) minutes may be practiced, typically such extended time periods are excessive and wasteful. Sufficient passive or active mechanical action may take place between the wastewater and the coagulant during this time interval as to allow the intimate commingling of the waste particles with the coagulant prior to addition of the flocculent.

The dose of flocculent affects the flocculation of the coagulated particles and the later dewatering of the sludge. If either insufficient or excessive flocculent is injected into the wastewater stream, the sludge may not appropriately dewater. Flocculent doses of about 5 ppm to about 50 ppm, and more particular about 7 ppm to about 30 ppm, still more particularly about 10 to about 30 ppm in certain exemplary embodiments, are suitable. Prior to its addition to the wastewater, the anionic flocculent may be in a dry or emulsified form. The flocculent is desirably made into an aqueous solution having between about 0.01 weight percent and about 0.5 weight percent flocculent, with 0.2 weight percent being particularly useful. A flocculent that may be used in exemplary and other embodiments described herein is poly(acrylamide-co-acrylate), also known as sodium acrylate acrylamide. Other flocculents may be used, such as an anionic polymer or copolymer formed from acrylic acid, methacrylic acid, and/or 2-acrylamido-2-methylpropanesulfonic acid and salts (e.g., sodium salts) thereof, e.g., copolymerized with acrylamide, methacrylamide, etc.

In exemplary embodiments, the dry or emulsified anionic flocculent has a charge density of at least about twenty percent (20%) and up to about sixty percent (60%), and in certain exemplary embodiments more particularly at least about thirty percent (30%), or more particularly at least about thirty-five percent (35%), or more particularly at least about fifty percent (50%). Again depending on wastewater stream strength, the flocculent, particularly when used in a range of about 7 ppm to about 30 ppm, flocculates the coagulated particles to a level without requiring the additional use of coagulant aids, sludge conditioners, dewatering aids, and/or clarification chemicals. It should be understood that while the addition of such coagulant aids, sludge conditioners, dewatering aids, and/or clarification chemicals is not necessary, and indeed their exclusion may be preferable to reduce overall sludge production, the use of such aids and additives is not altogether forbidden.

Referring back to the FIGURE, after flocculent addition, a sufficient time, for example, at least about 2 seconds, is allowed for the flocculation to substantially complete to form a sludge prior to dewatering, or at least form flocculated waste particles of sufficient size to allow for their physical removal, preferably without the use of coagulant aids (i.e., for secondary, tertiary, or quaternary coagulation) or flocculation aids.

In the illustrated embodiment of the FIGURE, the sludge is separated from the clarified water. The sludge is generally then passed to a plate-and-frame sludge press (or other dewatering equipment), where the sludge is dewatered to form a sludge cake. The sludge cake and/or the clarified water may be disposed of. If the sludge is not dewatered, the sludge can be hauled away wet.

The coprecipitant reaction is very rapid. Typically, more than about eighty-five (85) weight percent, and typically more than about ninety-nine (99) weight percent, of the oil and grease are removed in the proper use of this exemplary method from the waste solution within about one minute after the formation of the agglomerated particle.

Exemplary methods of the invention are superior to conventional precipitation methods in that these exemplary methods also produce less precipitate sludge. The lower sludge production stems, in part, from the removal of separately or blended inorganic components including but not limited to: ferric chloride, ferrous sulfite, polyaluminum chloride, bentonite clay, perlite, diatomaceous earth, and/or (separately injected) aluminum chloride. In accordance with exemplary embodiments described herein, typical sludge generation may be reduced about 30-80 weight percent compared to traditional methods of industrial laundry wastewater treatment. Dewatering characteristics of the sludge in other prior art systems vary from system to system and do cause an additional “body feed” to the sludge in order to achieve dewaterability. As a result, whereas traditional methods required the addition of in-stream and downstream additives, such as coagulant aids, dewatering aids, sludge conditioners, etc., such additives are not necessary according to embodiments described herein, and the entire method is desirably yet optionally carried out free of such additives to review sludge production.

The following examples, are set forth to illustrate this invention and render same more understandable but are not intended to limit the scope of the herein disclosed and claimed invention.

### EXAMPLES

### Comparative Example A

Laundry plant #1 with an average water usage of 110,000 gallons per day with 50% of the input product being shop towels, mats, ink wipers and other heavy soils was producing 1.1% of its daily wastewater as liquid sludge.

The laundry plant #1 was practicing the method recited in U.S. Pat. Nos. 7,160,470 and 7,291,275 with a dose rate of 200-400 ppm of coagulant using a mix time of approximately 20 seconds, and the application of the flocculent at 20-30 ppm using a mix time of approximately 40 seconds, resulting in floc that was floated through mechanical means. The amount of sludge produced was 0.3% of the influent flow thereby resulting in a dewatered sludge reduction of 66%. All required effluent parameters were compliant with EPA requirements.

Inventive Example 1

The practices of laundry plant #1 were modified by replacing the coagulant with methanamine, N-methyl-, polymer with 2-(chloromethyl) oxirane and ACH with the subsequent dosing needed being reduced 150-300 ppm. Additional aids and conditioners used in Comparative Example A were excluded from the process of Example 1.

The effect on the plate and frame dewatering press was a reduction in the final amount of dewatered sludge to 35 cubic feet per day from 45 cubic feet per day, thus reducing disposal costs of the sludge, as well as substantial savings in treatment chemicals and other additives used in the prior program.

### Comparative Example B and Inventive Example 2

An industrial laundry with an average flow of 60,000 gallons per day wastewater treated with the method recited in U.S. Pat. Nos. 7,160,470 and 7,291,275 was modified to use 220 ppm of methanamine, N-methyl-, polymer with 2-(chloromethyl) oxirane and ACH coagulant injected prior to the transfer pump and 30 ppm of flocculent injected at the former clay injection point. Additional aids and conditions used in Comparative Example B were excluded from the process of Example 2. Sludge production was reduced from 350 to approximately 300 gallons per day. The plant remained compliant with on a standard clarity wedge. This new process formed sludge cakes by the press amounting to 7 cubic feet to approximately 4 cubic feet per day at 45% solids, and substantial savings in disposal costs were achieved.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the precise embodiments disclosed. The specification describes specific examples to accomplish a more general goal that may be accomplished in another way.

Only those claims which use the words “means for” are to be interpreted under 35 USC 112, sixth paragraph. Moreover, no limitations from the specification are to be read into any claims, unless those limitations are expressly included in the claims.

1. A method for clarifying wastewater containing contaminants, comprising:
adding a cationic blend consisting essentially of poly[2-hydroxypropyl-N,N-dimethylammonium chloride] and aluminum chlorohydrate (ACH) to the wastewater in an effective amount to break emulsified bonds of the contaminants in the wastewater and produce cationic-charged coagulated particles having sufficient mass and cationic charge to react with an anionic flocculent to be added thereafter; and
subsequent to a sufficient delay to permit the cationic blend to coagulate the cationic-charged coagulated particles in the wastewater, adding the anionic flocculent to the wastewater in an effective amount to react with the cationic-charged coagulated particles to form flocculated waste particles of effective size to form sludge in disposable clarified water.

2. The method of claim 1, further comprising:
separating the sludge from the clarified water. passing the sludge to a plate and frame sludge press;
dewatering the sludge by the press, thereby forming a disposable sludge cake; and
disposing of the sludge cake and the clarified water.

3. The method of claim 1, wherein the sufficient delay is at least two seconds.

4. The method of claim 3, wherein the anionic flocculent comprises poly(acrylamide-co-acrylate).

5. The method of claim 1, wherein the cationic-charged coagulated particles, the flocculated waste particles, and the disposable clarified water are formed in the method without addition of a coagulant aid and without addition of a flocculation aid.

6. A method for clarifying wastewater containing contaminants, comprising:
(a) adding a cationic blend consisting essentially of poly[2-hydroxypropyl-N,N-dimethylammonium chloride] and aluminum chlorohydrate (ACH) in an amount of between about 25 ppm and about 1500 ppm to the wastewater to break emulsified bonds of the contaminants in the wastewater and produce cationic-charged coagulated particles having sufficient mass and cationic charge to react with an aqueous anionic polymer flocculent to be added thereafter;
(b) delaying addition of the aqueous anionic polymer flocculent by at least a sufficient time to permit the cationic blend to substantially complete the coagulation of the cationic-charged coagulated particles in the wastewater in said adding (a); and
(c) adding the aqueous anionic polymer flocculent in an amount between about 5 ppm and about 50 ppm and of sufficient molecular weight and charge density to the wastewater so as to react with the cationic-charged coagulated particles to form flocculated waste particles of effective size to form sludge in disposable clarified water.

7. The method of claim 6, further comprising:
(d) separating the sludge from the clarified water.
(e) passing the sludge to a plate and frame sludge press;
(f) dewatering the sludge by the press, thereby forming a disposable sludge cake; and
(g) disposing of the sludge cake and the clarified water.

8. The method of claim 6 wherein the predetermined time in said delaying (b) is at least two seconds.

9. The method of claim 6 wherein the anionic polymer flocculent comprises poly(acrylamide-co-acrylate).

10. The method of claim 6 wherein the anionic polymer flocculent is dry, and wherein the method further comprises:
(h) wetting the anionic polymer flocculent to a solution strength of about between 0.02 and 0.50% by weight prior to said adding (c).

11. The method of claim 10 wherein the sufficient time in step (b) is at least two seconds and the anionic polymer flocculent comprises poly(acrylamide-co-acrylate) added as a wetted solution having a strength of between 0.02 and 0.50% by weight of the wetted solution prior to said adding (c).

12. The method of claim 6, wherein the charge density of the aqueous anionic polymer flocculent is at least 30%.

13. The method of claim 6, wherein the cationic blend is water dispersed prior to said adding (a).

14. The method of claim 6, wherein the wastewater comprises industrial laundry wastewater.

15. The method of claim 14, wherein the contaminants comprise surfactants, fats, oil and grease, total petroleum hydrocarbon, biochemical oxygen demand, chemical oxygen demand, total suspended solids, and ionized metals.

16. The method of claim 6, wherein the cationic-charged coagulated particles, the flocculated waste particles, and the disposable clarified water are formed in the method without addition of a coagulant aid and without addition of a flocculation aid.

17. The method of claim 6, wherein the effective amount of the aqueous anionic polymer flocculent is on the order of between 5 ppm and 50 ppm.

18. The method of claim 17 wherein the anionic polymer flocculent comprises poly(acrylamide-co-acrylate).

19. A method for clarifying wastewater containing contaminants, comprising:
(a) adding a cationic blend about 5 to about 50 weight percent consisting essentially of poly[2-hydroxypropyl-N,N-dimethylammonium chloride] and about 5 to about 40 weight percent aluminum chlorohydrate (ACH) to the wastewater in an amount of between about 25 ppm and about 1500 ppm to break emulsified bonds of the contaminants in the wastewater and produce cationic-charged coagulated particles having sufficient mass and cationic charge to react with an aqueous anionic polymer flocculent to be added thereafter;
(b) delaying addition of the aqueous anionic polymer flocculent by at least a sufficient time to permit the cationic blend to substantially complete the coagulation of the cationic-charged coagulated particles in the wastewater in said adding (a); and
(c) adding the aqueous anionic polymer flocculent in an amount between about 5 ppm and about 50 ppm and of sufficient molecular weight and charge density to the wastewater so as to react with the cationic-charged coagulated particles to form flocculated waste particles of effective size to form sludge in disposable clarified water.

20. The method of claim 19, wherein:
the predetermined time in said delaying (b) is at least two seconds;
the anionic polymer flocculent comprises poly(acrylamide-co-acrylate); and
the charge density fo the anionic polymer flocculent is at least 20%.

21. The method of claim 19, wherein the cationic-charged coagulated particles, the flocculated waste particles, and the disposable clarified water are formed in the method without addition of a coagulant aid and without addition of a flocculation aid.
